(19) United States
(12) Patent Application Publication
(10) Pub. No.: US 2002/0141080 A1
(43) Pub. Date: Oct. 3, 2002

(54) Lens barrel

(75) Inventor: Kazuhiko Onda, Saitama-shi (JP)

Correspondence Address: LEYDIG VOIT & MAYER, LTD, 700 THIRTEENTH ST. NW, SUITE 300, WASHINGTON, DC, 20005-3960, US

(73) Assignee: FUJI PHOTO OPTICAL CO. LTD., Saitama-shi (JP)

(21) Appl. No.: 10/105,440

(22) Filed: Mar. 26, 2002

(30) Foreign Application Priority Data
Mar. 27, 2001 (JP) 2001-090706

(51) Int. Cl. G02B 15/14; G02B 7/02

(52) U.S. Cl. 359/821; 359/819; 359/699; 359/700

(57) ABSTRACT

A lens barrel 1 for accommodating a lens optical system has a fixed frame 6 formed with an opening 10 for attaching thereto a holding frame 13 for holding a CCD 12, whereas the holding frame 13 is attached to the opening 10 such that the CCD 12 is positioned at an image plane 11 of a taking optical system set at the opening 10. Since the holding frame 13 is constructed separately from the fixed frame 6, the latter can be molded easily, whereby the peripheral face of the fixed frame 6 can be formed with a tapered-in cam groove 9. Therefore, an intermediate cylinder 7 can stably be held by way of the cam groove 9, whereby the strength against external forces can be improved.

### BACKGROUND OF THE INVENTION

1. Field of the Invention

The present invention relates to a lens barrel employed in a lens optical system of a digital camera and the like.

2. Related Background Art

Conventionally known as a lens barrel of a camera is one having a plurality of tubular bodies expandable in a multistage fashion, and a lens optical system arranged within the tubular bodies, in which an inner tubular body is expanded or collapsed in response to a zooming operation, so as to change power and adjust focusing.

On the other hand, the development of digital cameras which take pictures by using imaging devices such as CCD without silver halide films has remarkably been in progress in recent years. In such a digital camera, an imaging device is disposed at the image plane of its taking lens optical system, and photographed images are converted by the imaging device into electric signals so as to be stored.

From the viewpoint of reducing size, the taking optical system of the digital camera may be configured such that, as shown in FIG. 4, the image plane 101 of the taking optical system 101 is formed inside a lens barrel 100, a holding part 104 of a CCD 103 is formed at an end part of a fixed frame 102 constituting the lens barrel 100, and the CCD 103 is fixedly disposed at the holding part 104.

### SUMMARY OF THE INVENTION

However, the lens barrel shown in FIG. 4 has the following problems. Namely, since the holding part 104 holding the CCD 103 is formed so as to project inside the fixed frame 102, if the fixed frame 102 having a cam groove 105 at the peripheral face thereof is to be made, it will be difficult to mold the cam groove 105 by pulling a slide die put on the inside face of the fixed frame 102. For forming the cam groove 105 by molding in this case, it is necessary that the slide die put on the outside face of the fixed frame 102 be pulled. Therefore, the cam groove 105 has a tapered-out form so as to become wider toward the outer periphery. When a cam follower 106 is inserted into the cam groove 105 from the inside, the contact area between the cam groove 105 and cam follower 106 becomes small, whereby the cam groove 105 fails to stably hold a tubular body 107 having the cam follower 106.

Since the fixed frame 102 is formed with the holding part 104 of the CCD 103, it will be difficult to correct postural shifts of the CCD 103 with respect to the image plane 101 or the like when making the lens barrel 100. In case a postural shift is generated after the CCD 103 is fixed, for example, an operation for removing the CCD 103 from the holding part 104 and fixing it again is necessary, which complicates the correcting operation. As a consequence, the lens barrel 100 cannot be made efficiently.

Further, when the fixed frame 102 is formed with the holding part 104 of the CCD 103, the opening area of the opening 108 at an end part of the fixed frame 102 becomes small. This makes it difficult to place inspection devices such as a collimator at the image plane 101 when making the lens barrel 100. Therefore, inspections for optical performances of the taking optical system are carried out through output images of the CCD 103, whereby the taking optical system cannot be inspected directly. For accurately grasping causes of failures in the making of the lens barrel 100, it is desirable that aerial images of the taking optical system be checked directly.

For overcoming such problems, it is an object of the present invention to provide a lens barrel which has a high strength against external forces and can be made efficiently.

For achieving such an object, the lens barrel in accordance with one aspect of the present invention is a lens barrel for accommodating a lens optical system, the lens barrel comprising a tubular member having an opening at one of end parts, in which an image plane is formed at a position of the opening by the lens optical system; and an imaging device holding member, constructed separately from the tubular member, for holding an imaging device, the imaging device holding member being attached to the opening of the tubular member and placing the imaging device at the image plane.

The lens barrel in accordance with another aspect of the present invention is a lens barrel for accommodating a lens optical system, the lens barrel comprising a tubular member having an opening at one of end parts, in which an image plane is formed at a position inside the opening by the lens optical system; and an imaging device holding member, constructed separately from the tubular member, for holding an imaging device, the imaging device holding member being attached to the opening of the tubular member and placing the imaging device at the image plane.

According to these aspects of the invention, an imaging device holding member for holding an imaging device is constructed separately from a tubular member, whereby it is not necessary to form an imaging device holding part as a part of the tubular member projecting inside thereof for placing the imaging device at the image plane. Therefore, when making the tubular member, it can be formed by a slide die sliding on the inside face of the tubular member, whereby the peripheral face of the tubular member can be formed with a cam groove having a tapered-in form. As a consequence, a tapered cam follower can be inserted into the cam groove from the inside, so that the cam groove and the cam follower come into face-to-face contact with each other, thereby increasing their contact area, which makes it possible for the tubular member to stably hold, by way of the cam groove, the member formed with the cam follower.

Since the imaging device holding member for holding the imaging device is constructed separately from the tubular member, the posture of arrangement of the imaging device can easily be adjusted by regulating the attaching posture of the imaging device holding member when attaching the imaging device holding member to the tubular member. Also, shifts in arrangement such as tilts of the imaging device with respect to the image plane can easily be corrected.

When the imaging device holding member is removed from the tubular member at the time of making the lens barrel, inspection devices such as a collimator can be placed at the image plane. Hence, aerial resolutions of the lens optical system can directly be detected, so as to inspect optical performances of the lens optical system.

The lens barrel in accordance with still another aspect of the present invention is a lens barrel for accommodating a lens optical system and enabling the lens optical system to change power and adjust focus, the lens barrel comprising a first tubular body having a peripheral face formed with a cam groove, and an opening at one of end parts, in which an image plane is formed at the opening by the lens optical system; an imaging device holding member, constructed separately from the first tubular body, for holding an imaging device, the imaging device holding member being attached to the opening of the first tubular body and placing the imaging device at the image plane; and a second tubular body having a cam follower inserted into the cam groove of the first tubular body, the second tubular body being provided so as to be expandable and collapsible with respect to the first tubular body.

The lens barrel in accordance with still another aspect of the present invention is a lens barrel for accommodating a lens optical system and enabling the lens optical system to change power and adjust focus, the lens barrel comprising a first tubular body having a peripheral face formed with a cam groove, and an opening at one of end parts, in which an image plane is formed inside the opening by the lens optical system; an imaging device holding member, constructed separately from the first tubular body, for holding an imaging device, the imaging device holding member being attached to the opening of the first tubular body and placing the imaging device at the image plane; and a second tubular body having a cam follower inserted into the cam groove of the first tubular body, the second tubular body being provided so as to be expandable and collapsible with respect to the first tubular body.

The lens barrel in accordance with still another aspect of the present invention enables a plurality of tubular bodies to expand and collapse in a multistage fashion, wherein the first and second tubular bodies constitute a part or all of the plurality of tubular bodies.

The lens barrel in accordance with still another aspect of the present invention is characterized in that the cam follower of the second tubular body is a tapered projection and is inserted into the cam groove from the inner periphery side of the first tubular body.

The lens barrel in accordance with still another aspect of the present invention is characterized in that the lens optical system is a taking optical system of a digital camera.

According to these aspects of the present invention, an imaging device holding member for holding an imaging device is constructed separately from a first tubular body, whereby it is not necessary to form an imaging device holding part as apart of the first tubular body projecting inside thereof for placing the imaging device at the image plane. Therefore, when making the first tubular body, it can be formed by a slide die sliding on the inside face of the first tubular body, whereby the peripheral face of the first tubular body can be formed with a cam groove having a tapered-in form. As a consequence, a tapered cam follower can be inserted into the cam groove from the inside, so that the cam groove and the cam follower come into face-to-face contact with each other, thereby increasing their contact area, which makes it possible for the first tubular body to stably hold, by way of the cam groove, a second tubular body.

Since the imaging device holding member for holding the imaging device is constructed separately from the first tubular body, the posture of arrangement of the imaging device can easily be adjusted by regulating the attaching posture of the imaging device holding member when attaching the imaging device holding member to the first tubular body. Also, shifts in arrangement such as tilts of the imaging device with respect to the image plane can easily be corrected.

When the imaging device holding member is removed from the first tubular body at the time of making the lens barrel, inspection devices such as a collimator can be placed at the image plane. Hence, aerial resolutions of the lens optical system can directly be detected, so as to inspect optical performances of the lens optical system.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is an explanatory view of the lens barrel in accordance with an embodiment of the present invention;

FIG. 2 is an explanatory view of the structure of a fixed frame in the lens barrel of FIG. 1;

FIG. 3 is an explanatory view of an optical performance test for the lens barrel of FIG. 1; and

FIG. 4 is an explanatory view of a conventional technique prior to the present invention.

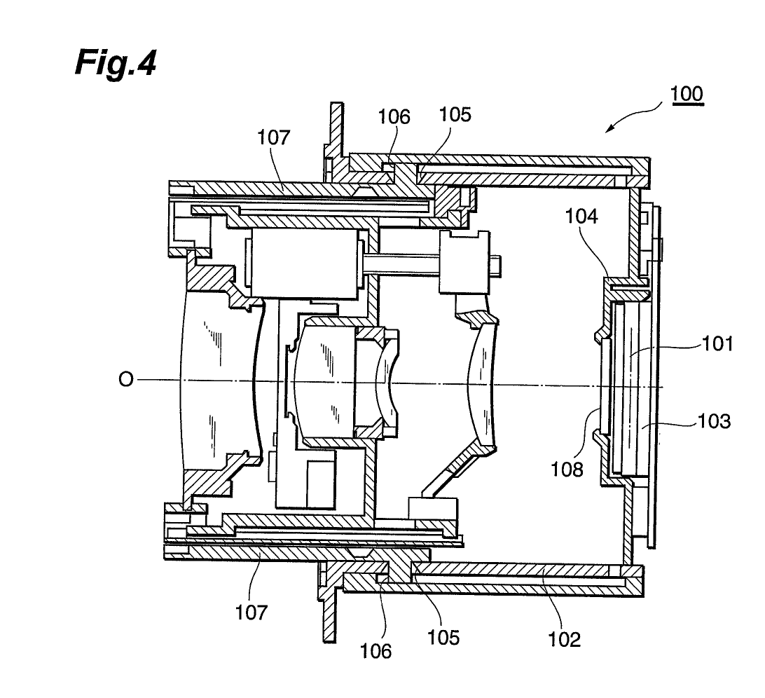

### DESCRIPTION OF THE PREFERRED EMBODIMENTS

In the following, embodiments of the present invention will be explained with reference to the drawings. Among the drawings, parts identical to each other will be referred to with numerals or letters identical to each other without repeating their overlapping descriptions. Also, ratios of dimensions in the drawings do not always match those explained.

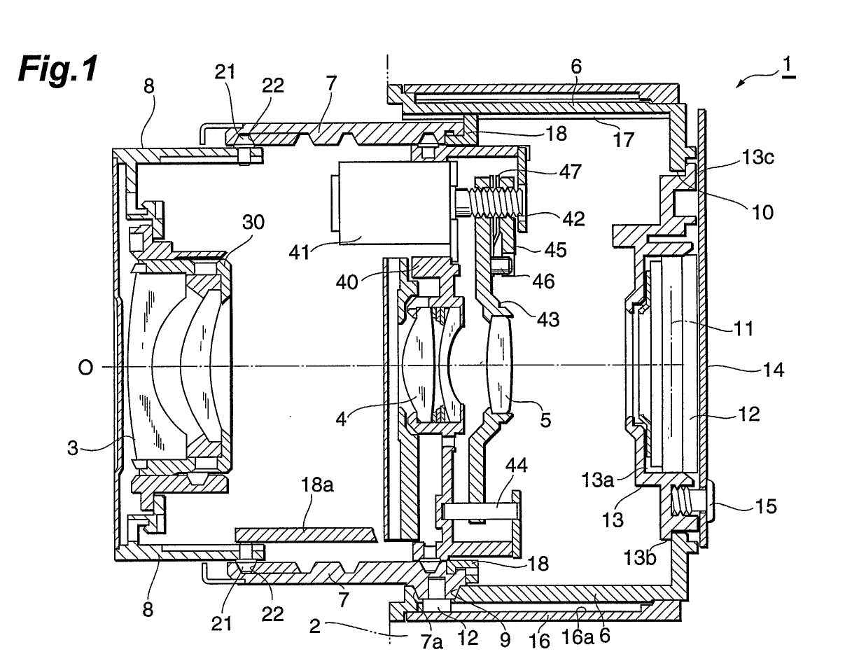

FIG. 1 shows an explanatory view of the lens barrel in accordance with an embodiment. As shown in this drawing, the lens barrel 1 in accordance with this embodiment is used for a taking optical system of a camera 2. Accommodated in the lens barrel 1 are a first lens group 3, a second lens group 4, and a third lens 5 which constitute the taking optical system of the camera 2.

The lens barrel 1 comprises a fixed frame 6 secured to the body of camera 2, an intermediate cylinder 7 expandable and collapsible with respect to the fixed frame 6, and a movable cylinder 8 expandable and collapsible with respect to the intermediate cylinder 7.

The fixed frame 6 is a tubular member having an opening 10 at one end while leaving the other end open. In the taking optical system, an image plane 11 is formed at the opening 10. The opening 10 is used as an attachment space for attaching a holding frame 13 of a CCD 12 acting as an imaging device. The holding frame 13 is constructed separately from the fixed frame 6, and is attached to the opening 10 of the fixed frame 6. The image plane 11 may also be set inside the fixed frame 6 from the opening 10.

The holding frame 13 is formed with an attachment 13a for attaching the CCD 12 thereto. The holding frame 13 is attached to the opening 10 with its end parts 13b, 13c engaging edge parts of the opening 10. A pressure plate 14 is fastened with a screw 15 so that the holding frame 13 is attached to the opening 10. The pressure plate 14 causes the holding frame 13 to be held at the opening 10, whereby the CCD 12 is held by the holding frame 13. The CCD 12 held by the holding frame 13 is disposed at the image plane 11.

Since the holding frame 13 is provided separately from the fixed frame 6 as such, the posture of arrangement of the CCD 12 can easily be adjusted by regulating the attaching state of the holding frame 13 holding the CCD 12 when attaching the holding frame 13 to the fixed frame 6 at the time of making the camera 2. Also, shifts in arrangement such as tilts of the CCD 12 with respect to the image plane 11 can easily be corrected.

Since the holding frame 13 and CCD 12 can be removed from the fixed frame 6 by taking out the screw 15, the holding frame 13 and CCD 12 can easily be attached to and detached from the fixed frame 6. Further, it is easy to replace a failed CCD 12, for example.

The peripheral face of the fixed frame 6 is formed with a cam groove 9. The cam groove 9 is formed through the peripheral face of the fixed frame 6, for example, in a spiral form along the peripheral face. The cam groove 9 has a cross section in a tapered-inform. Here, “tapered-in form” refers to a configuration in which the side face of the cam groove 9 is tapered out toward the inside of the fixed frame 6. By contrast, “tapered-out form” refers to a configuration in which the side face of the cam groove 9 is tapered out toward the outside of the fixed frame 6.

A cam follower 7a of the intermediate cylinder 7 is inserted into the cam groove 9. The cam follower 7a is a projection protruding outside from the outer peripheral face of the intermediate cylinder 7. Preferably, the cam follower 7a is formed into a tapering circular truncated cone. In this case, the cam follower 7a just fits into the cam groove 9 having a tapered-in form, thereby increasing the contact area between the outer face of the cam follower 7a and the inner face of the cam groove 9. Therefore, the intermediate cylinder 7 can stably be held with the fixed frame 6 by way of the cam groove 9.

A pin 12 is attached to the leading end part of the cam follower 7a. The pin 12 is a member for transmitting a turning force to the intermediate cylinder 7, and is inserted into a longitudinal groove 16a formed in a rotary cylinder 16. The rotary cylinder 16 is a tubular member disposed outside the fixed frame 6 and rotates as being driven by a driving source such as a motor. The longitudinal groove 16a is formed by denting the inner peripheral face of the rotary cylinder 16, and extends along the optical axis of the taking optical system (along the optical axis O).

As the rotary cylinder 16 rotates, the pin 12 and cam follower 7a move circumferentially, also along the optical axis as being guided by the cam groove 9. Consequently, the intermediate cylinder 7 moves along the optical axis while rotating, so as to be expanded or collapsed with respect to the fixed frame 6.

The inner peripheral face of the fixed frame 6 is formed with a longitudinal groove 17 extending along the optical axis. The longitudinal groove 17 is a groove for stopping a linearly-advancing key ring 18 from rotating, and guiding the linearly-advancing key ring 18 along the optical axis. The linearly-advancing key ring 18 is an annular member having a diameter substantially the same as that of the intermediate cylinder 7 and engages the intermediate cylinder 7 at the rear end part of the intermediate cylinder 7 so as to be rotatable relative thereto. Hence, the linearly-advancing key ring 18 moves along the optical axis together with the intermediate cylinder 7 while allowing the latter to rotate.

The linearly-advancing key ring 18 is formed with a support part 18a extending forward. The support part 18a engages the rear end part of the movable cylinder 8, thereby preventing the movable cylinder 8 from rotating. The rear end of the movable cylinder 8 is provided with a pin 21 projecting from the outer peripheral face. The pin 21 is inserted into a cam groove 22 formed in the inner peripheral face of the intermediate cylinder 7. The cam groove 22 is formed, for example, in a spiral form along the inner peripheral face of the intermediate cylinder 7.

Even when the intermediate cylinder 7 rotates, the movable cylinder 8 does not rotate, since it is supported by the linearly-advancing key ring 18. In conformity to the trace of the cam groove 22, the pin 21 moves along the optical axis. Therefore, as the intermediate cylinder 7 rotates, the movable cylinder 8 moves along the optical axis, thereby expanding or collapsing with respect to the intermediate cylinder 7.

The first lens group 3 is secured to the movable cylinder 8 by way of a first lens holding frame 30 and the like, and moves along the optical axis in response to the expanding and collapsing of the movable cylinder 8. A second lens holding frame 40 for holding the second lens group 4 is secured to the intermediate cylinder 7. Therefore, the second lens group 4 moves along the optical axis in response to the expanding and collapsing of the intermediate cylinder 7.

A focus motor 41 is attached to the second lens holding frame 40. The focus motor 41 is a driving means for moving the third lens 5, which is a focus lens of the taking optical system, along the optical axis and is driven according to output signals of a range finder (not depicted), placed in the camera 2, for measuring the distance to the object.

The peripheral face of the rotary shaft 42 of the focus motor 41 is formed with a thread groove and functions as a lead screw. The rotary shaft 42 is in mesh with a third lens holding frame 43. A shaft 44 placed in the second lens holding frame 40 penetrates through the third lens holding frame 43. The shaft 44 functions as a guide shaft and rotation preventing means for the third lens holding frame 43. As the rotary shaft 42 of the focus motor 41 rotates, the third lens holding frame 43 and the third lens 5 move along the optical axis.

A nut plate 45 is in mesh with the rotary shaft 42. A leaf spring 47 is compressed between the nut plate 45 and the third lens holding frame 43. The leaf spring 47 urges the nut plate 45 and third lens holding frame 43 in directions by which they separate from each other. This urging eliminates the backlash in the meshing part between the rotary shaft 42 and third lens holding frame 43. As a consequence, even when the moving direction of the third lens 5 is changed over as the focus motor 41 rotates in reverse, the third lens 5 moves so as to follow the driving of the focus motor 41, whereby the focusing of the taking optical system is carried out precisely.

A pin 46 extending from the third lens holding frame 43 penetrates through the nut plate 45, thereby preventing the nut plate 45 from rotating with the rotary shaft 42.

The structure of the fixed frame in the lens barrel in accordance with this embodiment will now be explained.

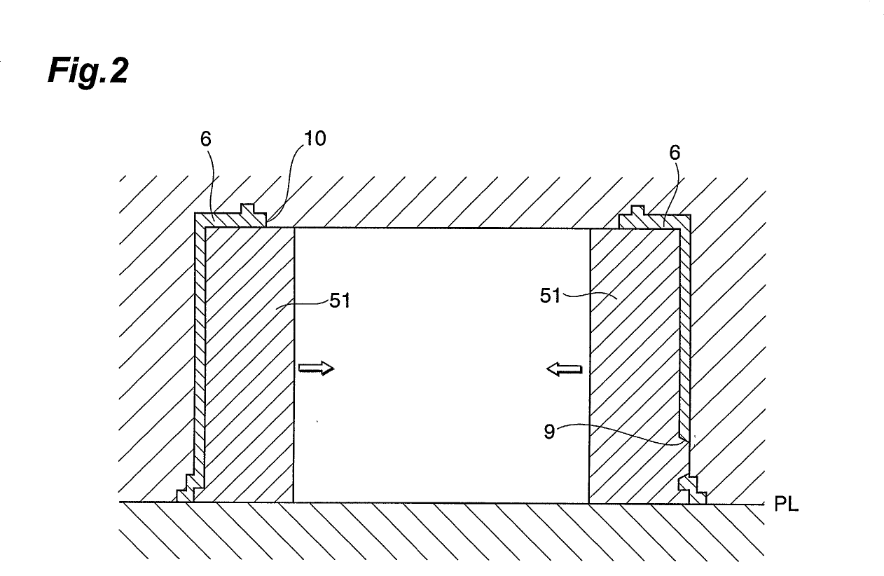

FIG. 2 shows an explanatory view of the structure of the fixed frame in the lens barrel in accordance with this embodiment. As shown in this drawing, the fixed frame 6 is a tubular member having the opening 10 at one end. As mentioned above, the fixed frame 6 is not formed with a holding part for the CCD 12, whereas the part corresponding thereto is formed with the opening 10, whereby there is no part projecting inside, such as a part projecting inside along the optical axis in particular.

Therefore, when molding the fixed frame 6 with a resin, the cam groove 9 can be molded with a slide die 51 sliding inside the fixed frame 6, whereby the cam groove 9 can be formed in a tapered-in form. Namely, a tapered cam groove 9 widening in a die-cutting direction can be formed when the cam groove 9 is molded such that slide dies 51, 51 are disposed inside the fixed frame 6 and then pulled inside the fixed frame 6.

When the tapered cam follower 7a is inserted into thus formed cam groove 9 from inside the fixed frame 6, the cam groove 9 and the cam follower 7a can come into face-to-face contact with each other, thereby increasing their contact area. Therefore, the fixed frame 6 can stably hold the intermediate cylinder 7 by way of the cam groove 9. This achieves a structure in which the intermediate cylinder 7 and the movable cylinder 8 are hard to break even when receiving an impact from the outside.

An optical performance test for the lens barrel in accordance with this embodiment will now be explained.

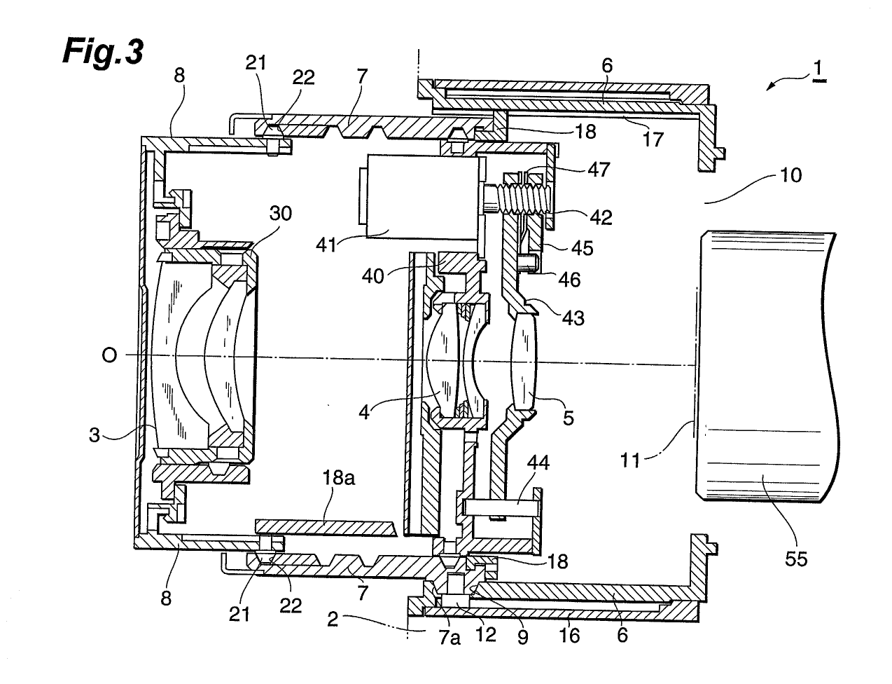

FIG. 3 shows an explanatory view of an optical performance test for the lens barrel in accordance with this embodiment. As shown in this drawing, the lens barrel 1 can open the opening 10 by removing the CCD 12, the holding frame 13, and the like from the fixed frame 6. In this state, a collimator 55 can be disposed at the opening 10 so as to carry out an optical inspection for the taking optical system of the lens barrel 1.

Therefore, aerial resolutions of the taking optical system can directly be detected, so as to check optical performances of the taking optical system. As a consequence, at the time of making and repairing the camera 2, for example, it is unnecessary to carry out optical performance tests of the taking optical system of the lens barrel 1 through output images of the CCD 12, whereby the taking optical system can be inspected directly. Hence, causes for failures in the making of the lens barrel 1 and the like can be grasped accurately, whereby the making, repairing, and the like of the lens barrel 1 can be carried out efficiently.

According to the lens barrel 1 in accordance with this embodiment, as in the foregoing, the holding frame 13 for holding the CCD 12 is constructed separately from the fixed frame 6, so that the fixed frame 6 has a simple structure, whereby the peripheral face of the fixed frame 6 can be formed with the tapered-in cam groove 9 by molding. Therefore, the tapered cam follower 7a can be inserted into the cam groove 9 from inside, so that the cam groove 9 and the cam follower 7a fully come into contact with each other, whereby the intermediate cylinder 7 can stably be held by way of the cam groove 9. As a consequence, the strength against external forces can be improved.

Since the holding frame 13 is constructed separately from the fixed frame 6, the posture of arrangement of the CCD 12 can easily be adjusted by regulating the attaching posture of the holding frame 13 when attaching the holding frame 13 to the fixed frame 6. Also, shifts in arrangement such as tilts of the CCD 12 with respect to the image plane 11 of the taking optical system can easily be corrected.

At the time of making the lens barrel 1, inspection devices such as the collimator 55 can be disposed at the image plane 11 in a state where the holding frame 13 and the like are removed from the fixed frame 6. As a consequence, aerial resolutions of the taking optical system can directly be detected, so as to inspect optical performances of the lens optical system, whereby appropriate tests can be carried out.

Though this embodiment relates to a case where the lens barrel in accordance with the present invention is employed in a digital camera, the lens barrel in accordance with the present invention is not limited thereto, but maybe employed in optical devices other than the digital camera, such as a video camera.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A lens barrel for accommodating a lens optical system, said lens barrel comprising:
a tubular member having an opening at one of end parts, in which an image plane is formed at a position of said opening by said lens optical system; and
an imaging device holding member, constructed separately from said tubular member, for holding an imaging device, said imaging device holding member being attached to said opening of said tubular member and placing said imaging device at said image plane.

2 A lens barrel for accommodating a lens optical system, said lens barrel comprising:
a tubular member having an opening at one of end parts, in which an image plane is formed at a position inside said opening by said lens optical system; and
an imaging device holding member, constructed separately from said tubular member, for holding an imaging device, said imaging device holding member being attached to said opening of said tubular member and placing said imaging device at said image plane.

3 A lens barrel for accommodating a lens optical system and enabling said lens optical system to change power and adjust focus, said lens barrel comprising:
a first tubular body having a peripheral face formed with a cam groove, and an opening at one of end parts, in which an image plane is formed at said opening by said lens optical system;
an imaging device holding member, constructed separately from said first tubular body, for holding an imaging device, said imaging device holding member being attached to said opening of said first tubular body and placing said imaging device at said image plane; and
a second tubular body having a cam follower inserted into said cam groove of said first tubular body, said second tubular body being provided so as to be expandable and collapsible with respect to said first tubular body.

4 A lens barrel for accommodating a lens optical system and enabling said lens optical system to change power and adjust focus, said lens barrel comprising:
a first tubular body having a peripheral face formed with a cam groove, and an opening at one of end parts, in which an image plane is formed inside said opening by said lens optical system;
an imaging device holding member, constructed separately from said first tubular body, for holding an imaging device, said imaging device holding member being attached to said opening of said first tubular body and placing said imaging device at said image plane; and
a second tubular body having a cam follower inserted into said cam groove of said first tubular body, said second tubular body being provided so as to be expandable and collapsible with respect to said first tubular body.

5 A lens barrel according to claim 3 enabling a plurality of tubular bodies to expand and collapse in a multistage fashion;
wherein said first and second tubular bodies constitute a part or all of said plurality of tubular bodies.

6 A lens barrel according to claim 4 enabling a plurality of tubular bodies to expand and collapse in a multistage fashion;
wherein said first and second tubular bodies constitute a part or all of said plurality of tubular bodies.

7 A lens barrel according to claim 3, wherein said cam follower of said second tubular body is a tapered projection and is inserted into said cam groove from the inner periphery side of said first tubular body.

8 A lens barrel according to claim 4, wherein said cam follower of said second tubular body is a tapered projection and is inserted into said cam groove from the inner periphery side of said first tubular body.

9 A lens barrel according to claim 1, wherein said lens optical system is a taking optical system of a digital camera.

10 A lens barrel according to claim 2, wherein said lens optical system is a taking optical system of a digital camera.
